(19) United States
(12) Patent Application Publication
(10) Pub. No.: US 2018/0039080 A1
(43) Pub. Date: Feb. 8, 2018

(54) HEAD UP DISPLAY WITH REDUCED PACKAGE DEPTH AND VOLUME

(71) Applicant: Panasonic Automotive Systems Company of America, Division of Panasonic Corporation of North America, PEACHTREE CITY, GA (US)

(72) Inventors: DAVID KAY LAMBERT, STERLING HEIGHTS, MI (US); WALTER JOSEPH NILL, DAVISON, MI (US)

(73) Assignee: Panasonic Automotive Systems Company of America, Division of Panasonic Corporation of North America

(21) Appl. No.: 15/666,633

(22) Filed: Aug. 2, 2017

Related U.S. Application Data
(60) Provisional application No. 62/370,458, filed on Aug. 3, 2016.

(51) Int. Cl. G02B 27/01; B60K 35/00; G02B 17/06

(52) U.S. Cl. CPC G02B 27/0149; G02B 27/0101; G02B 17/06; B60K 35/00; G02B 2027/015; B60K 2350/2065; B60K 2350/1072; B60K 2350/2052; B60K 2350/921

(57) ABSTRACT

A head up display arrangement for a motor vehicle includes an image source emitting a light field. A first freeform mirror is positioned to provide a first reflection of the light field. A generally concave second freeform mirror is positioned to receive the first reflection and provide a second reflection of the light field. The second reflection is reflected off of a windshield of the vehicle so as to be visible to a driver of the vehicle. An arcuate section of a surface of the generally concave second freeform mirror receives the first reflection and provides the second reflection. An angle between the first freeform mirror and an imaginary line that is tangent to a midpoint of the arcuate section of the surface of the generally concave second freeform mirror is approximately between thirty degrees and sixty degrees.

### CROSS-REFERENCED TO RELATED APPLICATIONS

This application claims benefit of U.S. Provisional Application No. 62/370,458 filed on Aug. 3, 2016, which the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

It is difficult for vehicle manufacturers to package a conventional head up display in a vehicle because of the volume required, and because the space under the dashboard is needed for other essential systems. In general, vehicle manufacturers need to package a head up display within the dashboard. Both the depth of the package and the volume of the package are important.

Automotive head up displays have traditionally had a field of view of about 5°×30 to present simple information, such as speed, below the driver's view of the road ahead. Increasingly, automakers would like to implement additional features, such as augmented reality, which require a larger field of view.

Current automotive head up displays primarily use a large concave mirror (aspherical) and a small flat mirror. Other current head up displays have two aspherical mirrors. Head up displays including a flat mirror oriented at about 45 degrees are also known.

### SUMMARY

The present invention may include a head up display having an optical arrangement that provides reduced package depth, smaller volume and improved image sharpness than is possible with the conventional optical design for an automotive head up display. The present invention may be applied to an augmented reality head up display with a 10°×4° virtual image as seen by the driver, and with a seven-meter virtual distance from the driver to the virtual image.

A novel aspect of the invention is that a first concave aspherical mirror may be oriented at an angle of about 45 degrees relative to a second approximately flat aspherical mirror in an automotive head up display, to reduce package depth, decrease volume, and improve image sharpness.

In one embodiment, the invention comprises a head up display arrangement for a motor vehicle, including an image source emitting a light field. A first freeform mirror is positioned to provide a first reflection of the light field. A generally concave second freeform mirror is positioned to receive the first reflection and provide a second reflection of the light field. The second reflection is reflected off of a windshield of the vehicle so as to be visible to a driver of the vehicle. An arcuate section of a surface of the generally concave second freeform mirror receives the first reflection and provides the second reflection. An angle between the first freeform mirror and an imaginary line that is tangent to a midpoint of the arcuate section of the surface of the generally concave second freeform mirror is approximately between thirty degrees and sixty degrees.

In another embodiment, the invention comprises a head up display method for a motor vehicle, including emitting a light field, and providing a first freeform mirror positioned to provide a first reflection of the light field. A generally concave second freeform mirror is provided and positioned to receive the first reflection and produce a second reflection of the light field. The second reflection is reflected off of a windshield of the vehicle so as to be visible to a driver of the vehicle. An arcuate section of a surface of the generally concave second freeform mirror receives the first reflection and produces the second reflection. An angle between the first freeform mirror and an imaginary line that is tangent to a midpoint of the arcuate section of the surface of the generally concave second freeform mirror is approximately between thirty degrees and sixty degrees.

In yet another embodiment, the invention comprises a head up display arrangement for a motor vehicle, including an image source emitting a light field. A first freeform mirror is positioned to provide a first reflection of the light field. A generally concave second freeform mirror has a reflective surface with an arcuate section. The arcuate section is positioned to receive the first reflection and provide a second reflection of the light field. An angle between the first freeform mirror and an imaginary line that is tangent to a midpoint of the arcuate section of the surface of the generally concave second freeform mirror is approximately between forty degrees and fifty degrees. A windshield is positioned to receive the second reflection and provide a third reflection of the light field. The third reflection is visible to a driver of the vehicle as a virtual image disposed outside of the windshield.

An advantage of the present invention is that it may reduce the required HUD volume and increase flexibility to package the HUD in the vehicle with other vehicle systems.

### BRIEF DESCRIPTION OF THE DRAWINGS

A better understanding of the present invention will be had upon reference to the following description in conjunction with the accompanying drawings.

FIG. 1 is a schematic bottom view of one example embodiment of a HUD optical arrangement of the present invention.

FIG. 2 is a schematic diagram of one example embodiment of a HUD system including the HUD optical arrangement of FIG. 1.

FIG. 3 is another schematic view of the mirrors and windshield of the HUD system of FIG. 2.

FIG. 4 is a schematic perspective view of the HUD system of FIG. 2.

FIG. 5 is a flow chart of one embodiment of a head up display method of the present invention for a motor vehicle.

### DETAILED DESCRIPTION OF THE PREFERRED EMBODIMENTS

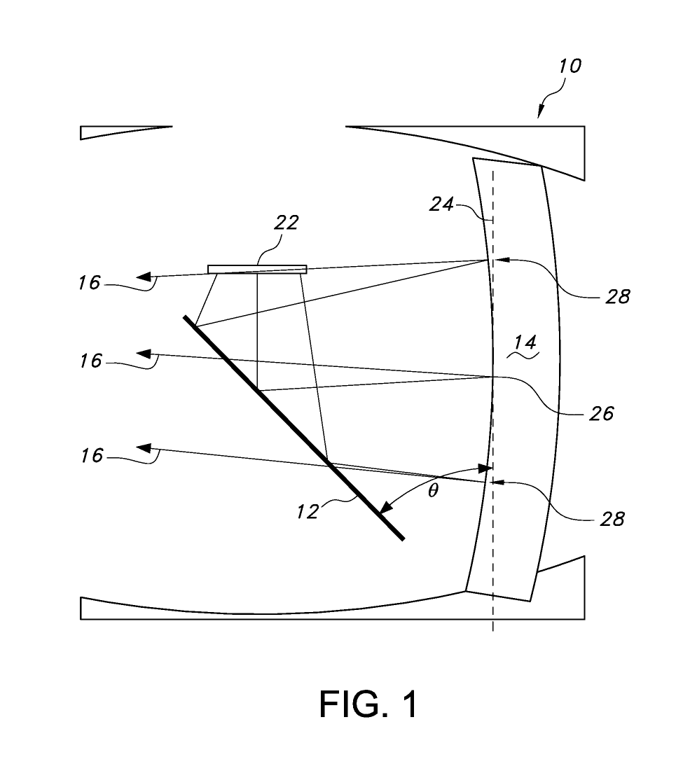

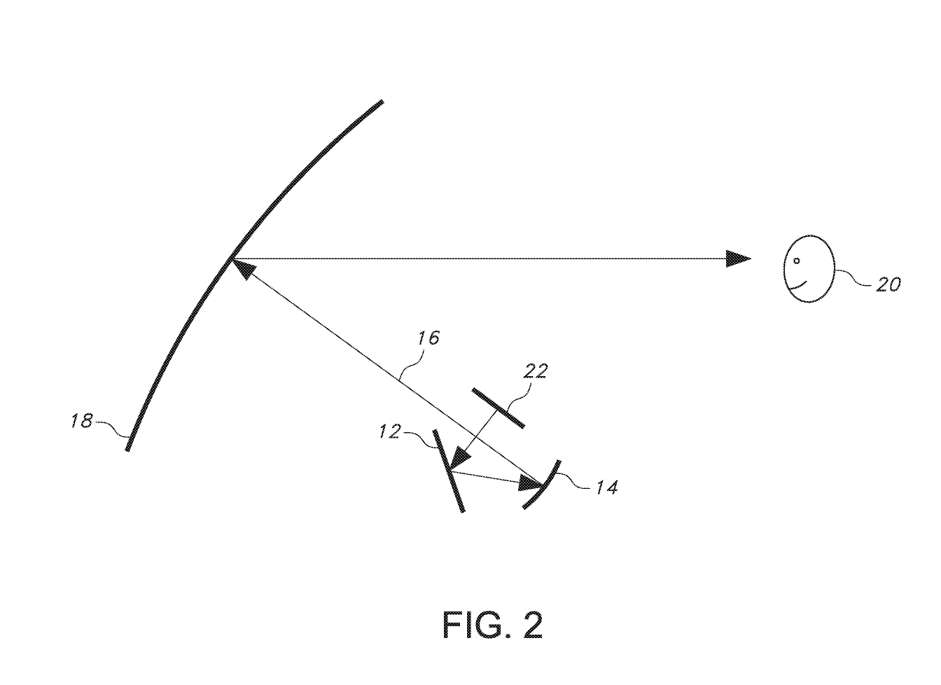

FIG. 1 illustrates one embodiment of a HUD optical arrangement 10 of the present invention, including two reflective freeform mirrors 12 and 14. Mirror 14 is concave and is arranged to aim rays 16 to reflect from a windshield 18, as shown in FIG. 2, to be seen by a human driver 20. Rays 16 begin at diffuser 22, reflect from mirror 12, pass from mirror 14 to windshield 18, and reflect from windshield 18 to be seen by the driver. Mirror 12 is approximately flat and is oriented to reflect light rays or a light field from a display, or from an image presented on a diffuser 22, to mirror 14. To simplify FIG. 2, diffuser 22 and the ray from diffuser 22 to mirror 12 have been rotated about the ray from mirror 12 to mirror 14 so as to be in the same plane as the other objects shown in FIG. 2.

In one embodiment, diffuser 22 is a diffuser supplied by Kuraray Co., Ltd., of Tokyo, Japan. The image on the diffuser is created by a projector. The projector may be a DLP projector such as a digital imaging system including micromirrors separately controlled to create a digital image. In one embodiment, a digital light projector or a digital multi-mirror device in a kit marketed from Texas Instruments, may be used as the image source.

In one specific embodiment, arrangement 10 is applied to a head up display for augmented reality with a 11.4°×4.30 field of view and a package volume of about 8.5 liters. The display may be in the form of a liquid crystal display having an 80×40 mm active area.

Imaginary line 24 is tangent to a midpoint 26 of an arcuate section 28 of the surface of mirror 14 that receives the light field reflected off of mirror 12. An angle θ between mirror 12 and tangent line 24 may be approximately between 30 degrees and 60 degrees. In one embodiment, angle θ may be approximately between 40 degrees and 50 degrees. In another embodiment, angle θ may be approximately 45 degrees. Tangent line 24 may alternatively be thought of as an imaginary plane that is perpendicular to the page of FIG. 1.

The concave curvature of the surface of mirror 14 may be modeled and/or designed with an extended polynomial description in a Zemax optical design software program. Other aspherical mirror types within Zemax that could be used to model and/or design mirror 14 include a Chebyshev polynomial description, a Zernike polynomial description, and a biconic Zernike description. Another optical design software program that may be used to model and/or design mirror 14 is Code V.

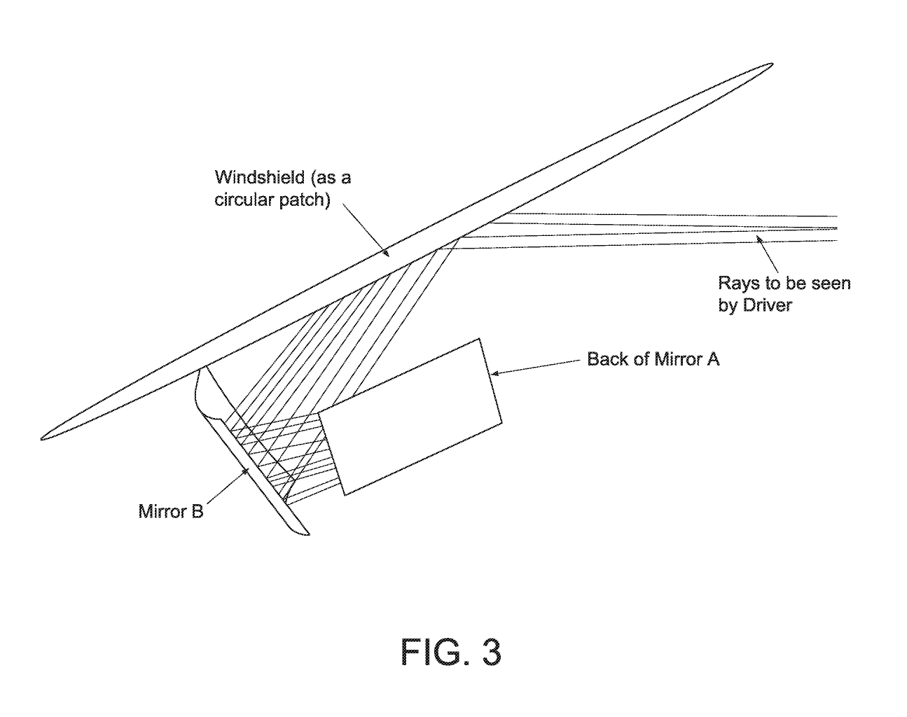

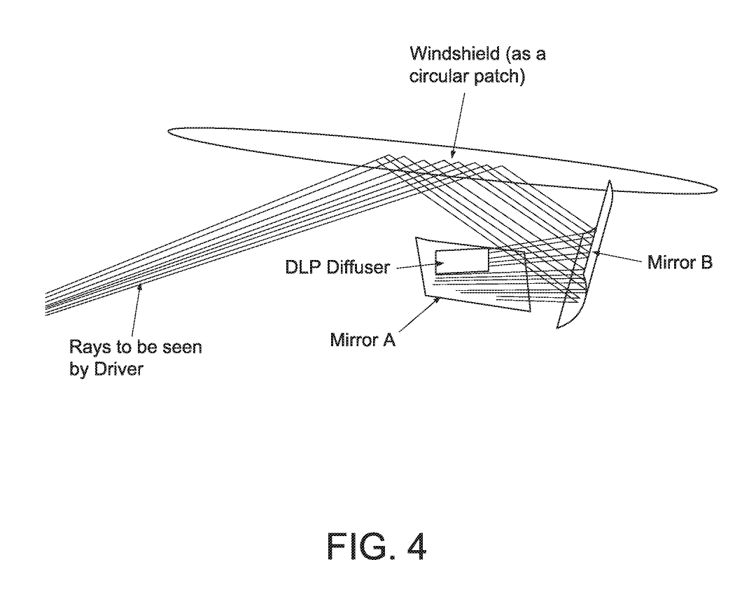

FIG. 3 illustrates the mirrors and windshield of the HUD system of FIG. 2. FIG. 4 illustrates the HUD system of FIG. 2. Mirror A in FIGS. 3-4 corresponds to mirror 12 in FIGS. 1-2, and mirror B in FIGS. 3-4 corresponds to mirror 14 in FIGS. 1-2.

Each of mirrors 12 and 14 may be a freeform mirror. The term “freeform” may mean that the mirror is not flat, conical, or frusto-conical, wherein cylindrical is considered to be a special case of conical. Mirror 14 may be generally concave, but mirror 12 may be neither generally concave nor generally convex. Mirror 12 may be approximately flat, but is designed to direct the rays appropriately. The reflective surface of mirror 12 may be described in Zemax as an extended polynomial with twenty-seven terms, wherein the X and Y are two perpendicular axes, and the value of the polynomial is the value of a third axis Z that is perpendicular to both of axes X and Y. The first two terms (X1Y0 and X0Y1) are constrained to zero, so the polynomial has twenty-five non-zero terms. The polynomial includes all possible terms in X, X², X³, X⁴, X⁵, X⁶, and Y, Y2, Y³, Y⁴, Y⁵, Y⁶.

In a particular embodiment, the equations for mirror 12 and mirror 14 are described in the table below:

| Term | Mirror 12 | Mirror 14 |
|---|---|---|
| X1Y0 | 0 | 0 |
| X0Y1 | 0 | 0 |
| X2Y0 | 3.758216827681000E+000 | 4.806211017163000E−001 |
| X1Y1 | 1.900693923567000E+000 | 9.257022901890000E−002 |
| X0Y1 | −4.409111247532000E+000 | 2.405827111339000E+000 |
| X3Y0 | 5.162006391704000E+000 | 1.639612087429000E−001 |
| X2Y1 | −3.061562001959000E+000 | −5.730690852151000E−001 |
| X1Y2 | −2.703129586368000E+000 | 1.432248526776000E−002 |
| X0Y3 | 1.596962055934000E+001 | 2.497339025215000E−001 |
| X4Y0 | 4.071721011694000E+000 | 3.430056338954000E−002 |
| X3Y1 | −2.815160693536000E+000 | 1.160820515645000E−001 |
| X2Y2 | 4.792150469313000E+000 | 2.051634427595000E−001 |
| X1Y3 | 1.471810878826000E+001 | −3.298219769185000E−001 |
| X0Y4 | 1.990887321837000E+001 | 6.728363234852000E−001 |
| X5Y0 | 1.512055949803000E+000 | −3.326563715569000E−002 |
| X4Y1 | −9.012755498883001E−001 | 3.903153809891000E−002 |
| X3Y2 | 4.234905523124000E+000 | −4.852380090258000E−002 |
| X2Y3 | 1.160242638340000E+001 | 1.987094538427000E−001 |
| X1Y4 | 1.578156095382000E+001 | −3.890998607212000E−001 |
| X0Y5 | −7.852204663376000E+000 | 4.018131700378000E−001 |
| X6Y0 | 2.134147672800000E−001 | 1.276349826294000E−002 |
| X5Y1 | −1.073218449779000E−001 | −4.083118180811000E−002 |
| X4Y2 | 9.179753579871000E−001 | −9.180506284074999E−003 |
| X3Y3 | 2.865078393453000E+000 | −7.129285790582000E−002 |
| X2Y4 | 4.869942297781000E+000 | 9.702818820677001E−002 |
| X1Y5 | −3.573718398775000E−001 | −1.072724576979000E−001 |
| X0Y6 | −9.147369578713001E+000 | 1.125279474755000E−001 |

For this embodiment, Z, the sum of all the terms, is vertical distance in mm. The variables X and Y are the respective horizontal distances in the X and Y direction, each divided by 100 mm (normalized to 100 mm). Accordingly, X and Y are dimensionless.

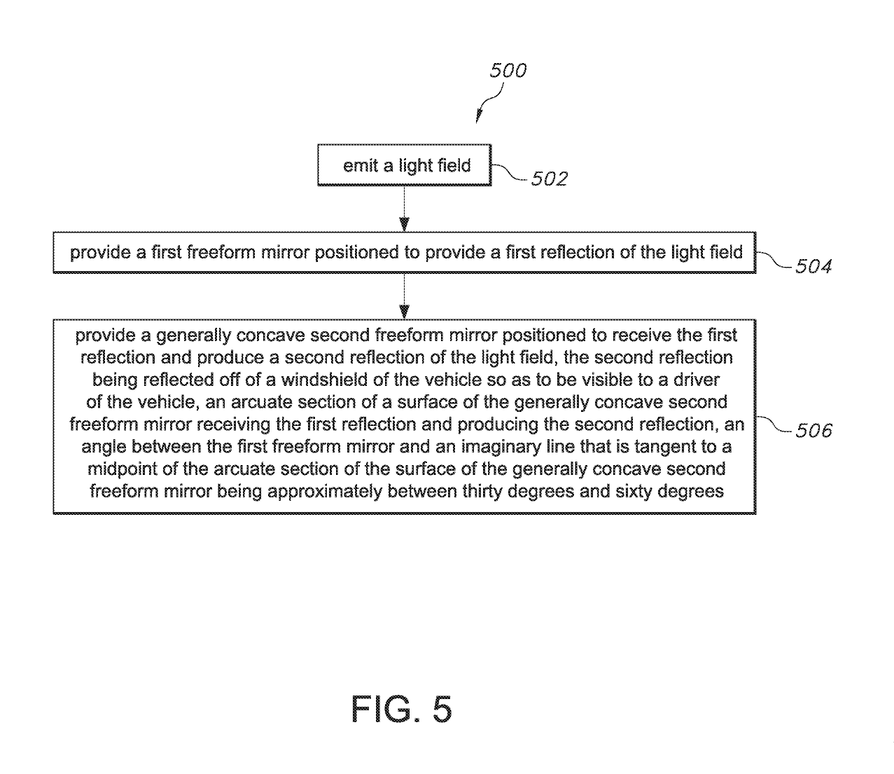

FIG. 5 illustrates one embodiment of a head up display method 500 of the present invention for a motor vehicle. In a first step 502, a light field is emitted. For example, diffuser 22 may emit a light field, as shown in FIGS. 1=2.

Next, in step 504, a first freeform mirror positioned to provide a first reflection of the light field is provided. For example, reflective freeform mirror 12 may be positioned to provide a first reflection of the light field emitted by diffuser 22.

In a final step 506, a generally concave second freeform mirror positioned to receive the first reflection and produce a second reflection of the light field is provided. The second reflection is reflected off of a windshield of the vehicle so as to be visible to a driver of the vehicle. An arcuate section of a surface of the generally concave second freeform mirror receives the first reflection and produces the second reflection. An angle between the first freeform mirror and an imaginary line that is tangent to a midpoint of the arcuate section of the surface of the generally concave second freeform mirror is approximately between thirty degrees and sixty degrees. For example, a generally concave second freeform mirror 14 may be positioned to receive the first reflection and produce a second reflection of the light field such that the second reflection is reflected off of windshield 18 of a vehicle so as to be visible to a driver 20 of the vehicle. An arcuate section 28 of the surface of mirror 14 receives the light field reflected off of mirror 12 and produces the second reflection. An angle θ between first freeform mirror 12 and an imaginary line 24 that is tangent to a midpoint 26 of arcuate section 28 of the surface of generally concave second freeform mirror 14 is approximately between thirty degrees and sixty degrees. The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle, the arrangement comprising:
an image source configured to emit a light field;
a first freeform mirror positioned to provide a first reflection of the light field; and
a generally concave second freeform mirror positioned to receive the first reflection and provide a second reflection of the light field, the second reflection being reflected off of a windshield of the vehicle so as to be visible to a driver of the vehicle, an arcuate section of a surface of the generally concave second freeform mirror receiving the first reflection and providing the second reflection, an angle between the first freeform mirror and an imaginary line that is tangent to a midpoint of the arcuate section of the surface of the generally concave second freeform mirror being approximately between thirty degrees and sixty degrees.

2. The head up display arrangement of claim 1 wherein the angle is approximately between forty and fifty degrees.

3. The head up display arrangement of claim 2 wherein the angle is approximately forty-five degrees.

4. The head up display arrangement of claim 1 wherein the image source comprises a diffuser.

5. The head up display arrangement of claim 1 wherein the generally concave second freeform mirror includes a curvature substantially described by an extended polynomial description in a Zemax optical design software program.

6. The head up display arrangement of claim 1 wherein the second reflection is reflected off of the windshield of the vehicle so as to be visible to the driver as a virtual image disposed outside the windshield and visible through the windshield.

7. The head up display arrangement of claim 6 wherein the virtual image is approximately between six and eight meters from the driver.

8. The head up display arrangement of claim 6 wherein the virtual image measures 10°×4° within a field of view of 11.4°×4.3° as seen by the driver.

9. A head up display method for a motor vehicle, the method comprising:
emitting a light field;
providing a first freeform mirror positioned to provide a first reflection of the light field; and
providing a generally concave second freeform mirror positioned to receive the first reflection and produce a second reflection of the light field, the second reflection being reflected off of a windshield of the vehicle so as to be visible to a driver of the vehicle, an arcuate section of a surface of the generally concave second freeform mirror receiving the first reflection and producing the second reflection, an angle between the first freeform mirror and an imaginary line that is tangent to a midpoint of the arcuate section of the surface of the generally concave second freeform mirror being approximately between thirty degrees and sixty degrees.

10. The method of claim 9 wherein the angle is approximately between forty and fifty degrees.

11. The method of claim 10 wherein the angle is approximately forty-five degrees.

12. The method of claim 9 wherein the light field is emitted by a diffuser.

13. The method of claim 9 wherein the generally concave second freeform mirror includes a curvature substantially described by an extended polynomial description in a Zemax optical design software program.

14. The method of claim 9 wherein the second reflection is reflected off of the windshield of the vehicle so as to be visible to the driver as a virtual image disposed outside the windshield and visible through the windshield.

15. The method of claim 14 wherein the virtual image is approximately between six and eight meters from the driver.

16. The method of claim 14 wherein the virtual image measures 10°×4° within a field of view of 11.4°×4.3° as seen by the driver.

17. A head up display arrangement for a motor vehicle, the arrangement comprising:
an image source configured to emit a light field;
a first freeform mirror positioned to provide a first reflection of the light field;
a generally concave second freeform mirror having a reflective surface with an arcuate section, the arcuate section being positioned to receive the first reflection and provide a second reflection of the light field, an angle between the first freeform mirror and an imaginary line that is tangent to a midpoint of the arcuate section of the surface of the generally concave second freeform mirror being approximately between forty degrees and fifty degrees; and
a windshield positioned to receive the second reflection and provide a third reflection of the light field, the third reflection being visible to a driver of the vehicle as a virtual image disposed outside of the windshield.

18. The head up display arrangement of claim 17 wherein the angle is approximately forty-five degrees.

19. The head up display arrangement of claim 17 wherein the generally concave second freeform mirror includes a curvature substantially described by an extended polynomial description in a Zemax optical design software program.

20. The head up display arrangement of claim 17 wherein the generally concave second freeform mirror includes a curvature substantially described by a Chebyshev polynomial description, a Zernike polynomial description, or a biconic Zernike description in a Zemax optical design software program.
